(19) United States
(12) Patent Application Publication
(10) Pub. No.: US 2007/0119996 A1
(43) Pub. Date: May 31, 2007

(54) Cone crusher for ore comminution

(76) Inventors: Luis Cerda, Huechuraba (CL); Claudio Valdes, Huechuraba (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/657,066

(22) Filed: Jan. 24, 2007

Related U.S. Application Data
(63) Continuation of application No. 11/042,340, filed on Jan. 26, 2005, now abandoned.

(51) Int. Cl. B02C 2/00

(52) U.S. Cl. 241/207

(57) ABSTRACT

A cone crusher mantle armor for ore comminution, comprising: a. grooves laid out in the form of spires or helixes over the mantle, where such grooves are integral to said mantle thus forming the mantle armor, and b. such grooves and said mantle are manufactured in a single casting.

### PRIORITY

This application is a continuation of U.S. Utility Application No. 11/042,340, which was filed on Jan. 26, 2005.

### FIELD OF THE INVENTION

The present invention refers to a cone crusher for ore comminution; particularly, it refers to a new conception of the mantle surface, and more specifically, to a mantle armor with a new geometry, which incorporates a set of embossed spirals that have a spline-type geometry, in which said mantle armor and its respective spires are molded and made by one single casting.

### DESCRIPTION OF THE RELATED ART

This invention is related to the ore comminution processes by means of machines that reduce its size, cone crushers, which consist of a mantle or post that turns eccentrically within a cup or nut, producing the ore comminution. During the grinding process the walls of the mantle and the cup wear down due to abrasion and impacts. Said wear is absorbed by some elements called armors that need to be replaced at a certain rate. The element that absorbs wear produced in the nut is known as nut or cup armor, while the element that absorbs wear produced in the mantle is known as mantle or post armor. Presently, armors have a different geometry, based on the grain size that is fed to the crusher.

Commonly, in ore grinding processes the armors that are used over the mantles have flat surfaces, which are obviously subject to a greater wear and, therefore, their useful life is glaringly reduced.

One example of a previous design that tried to solve the wear problem of grinding mantles is U.S. Pat. No. 5,516,053, which consists of a mantle armor and a cup armor that have welded concentric circles added made of abrasion-resistant materials. According to this publication, it is noticeable that the wear problem of the mantle and cup is approached by incorporating wear elements of great resistance, but these elements are welded to the mantle and cup surfaces, which in turn presents another disadvantage, namely that the welding process and materials should be strong enough to endure and avoid the detachment of the concentric rings over the mantle and cup surfaces. Also, such concentric weld beads are placed on circumferential grooves, which are previously turned, and this implies an additional step in the mantle manufacture. Without a doubt, the above significantly raises the manufacturing costs of this type of crusher, which—given the present conditions of the mining industry, specifically the copper industry—becomes very important for determining the margin of contribution of the product when it finally reaches the international markets.

Another very important aspect is related to the mechanical problems these types of cone crushers are subject to. Specifically, these problems are due to jamming or blockage of the grinded material between the mantle and cup surfaces, respectively, as the material is grinded and it approaches the setting area or the particle size defined in the lower part of the crusher. This problem cannot be solved by the previously mentioned design, because although the mantle surface is not flat, it does not allow differentiating particle sizes in the space between mantle and cup since the clearance between them is constant.

This is why the two main problems mentioned above—premature wear, and jamming or blockage—should necessarily be solved in order to increase performance in the final production of metals. Basically, because such problems cause multiple maintenance stops, which in turn cause an obvious waste of time and, therefore, a decrease in the production levels, and also because these imply increasing the levels of investment for this type of crusher parts, so the final production cost is increased.

### SUMMARY OF THE INVENTION

As defined in the previous design, the comminution elements of cone crushers currently used have a reduced comminuting capacity due to their geometry and type of manufacture. The present invention is characterized by a noticeable increase in the comminution capacity, since the achieved geometry produces a larger contact surface and pressure with the ore, allowing for a better processing.

The type of manufacture of the present invention yields a higher structural impact resistance, which produces a significant increase of the useful life of these elements, and translates into a decrease in costs and maintenance stops.

The advantages of the invention, stated in the above paragraphs, may be summarized as follows:

a. Longer useful lives of mantle armors.

b. Better material distribution within the crusher, which produces a more homogeneous material.

c. Lower energy expenses, due to better homogenous grinding conditions.

d. Increase of the structural resistance.

e. Lower crusher jamming or blockage rates.

### BRIEF DESCRIPTION OF THE FIGURES

FIG. 1: Mantle armor plan view.

FIG. 2: Mantle armor side view.

FIG. 3: Mantle and cup cross section view.

FIG. 4: Mantle and cup cross section view of the previous design.

FIG. 5: Mantle cross section view that shows the layout of spires.

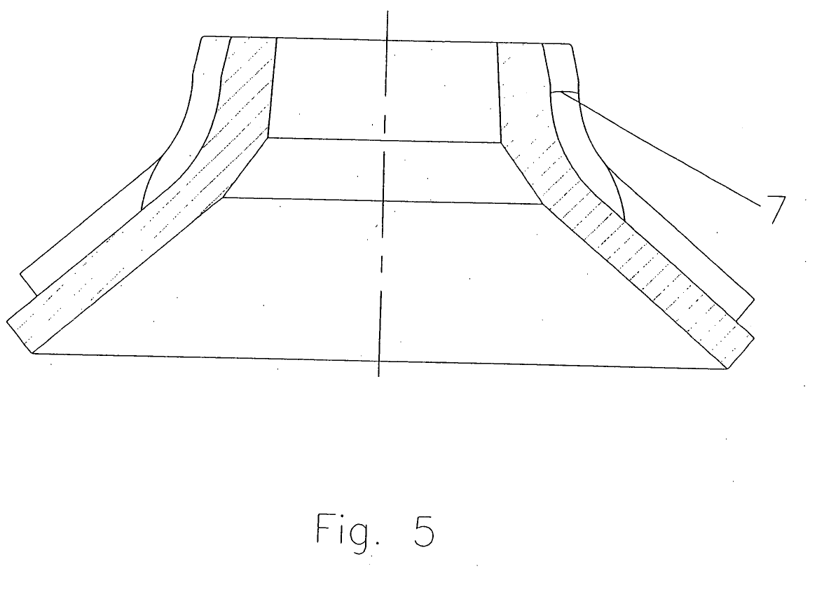

FIG. 6: Mantle plan view that shows its armor and the shape adopted by spires over the armor.

### DETAILED DESCRIPTION OF THE PREFERRED EMBODIMENTS

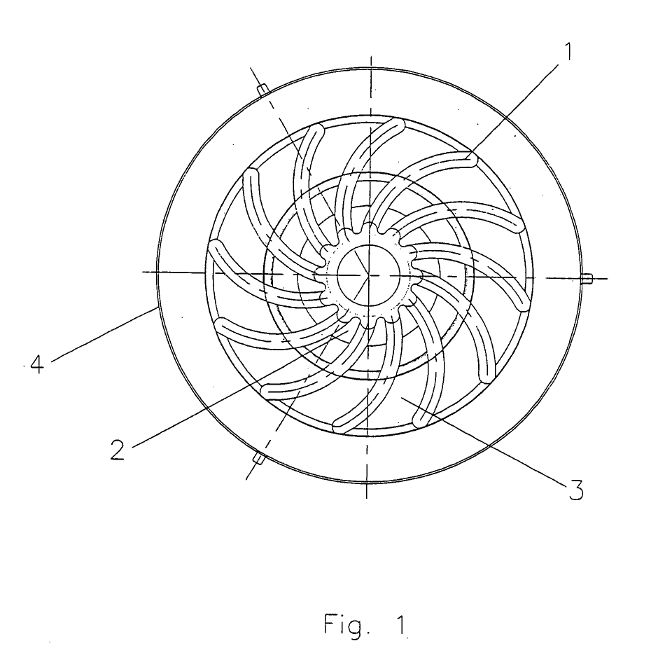

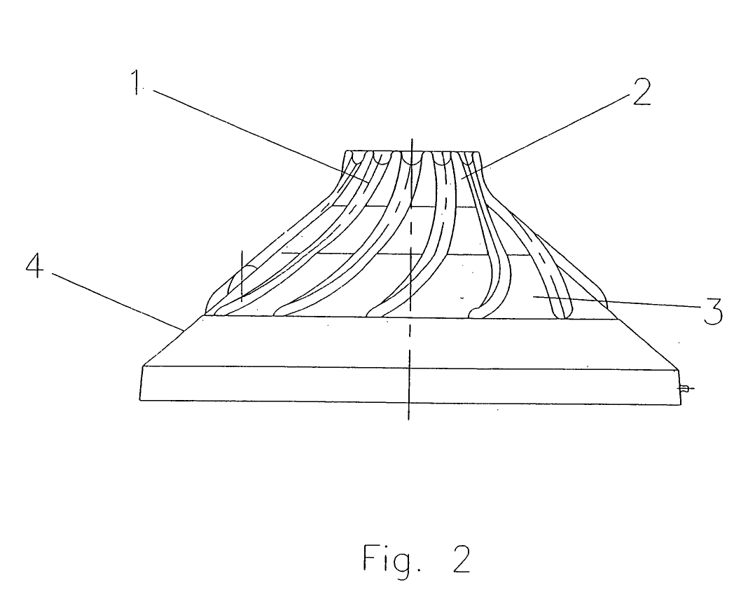

Regarding FIGS. 1 and 2, it is noticeable that the mantle armor, subject of the present invention, consists of grooves (1) integral to the mantle (4), which said grooves have the purpose of comminuting a high percentage of the material in the upper part (2) of the mantle (4). The mantle (4) together with the grooves (1) form what we call mantle armor.

Thus, the main objective of comminuting the material with the grooves (1) in the upper part (2) of the mantle (4) is to be able to comminute the less coarse material that has been produced during the comminution stage.

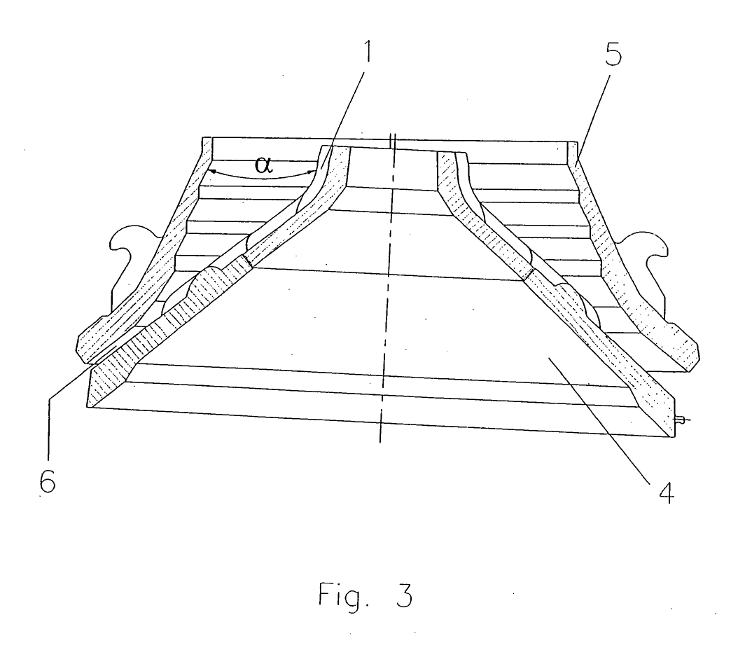

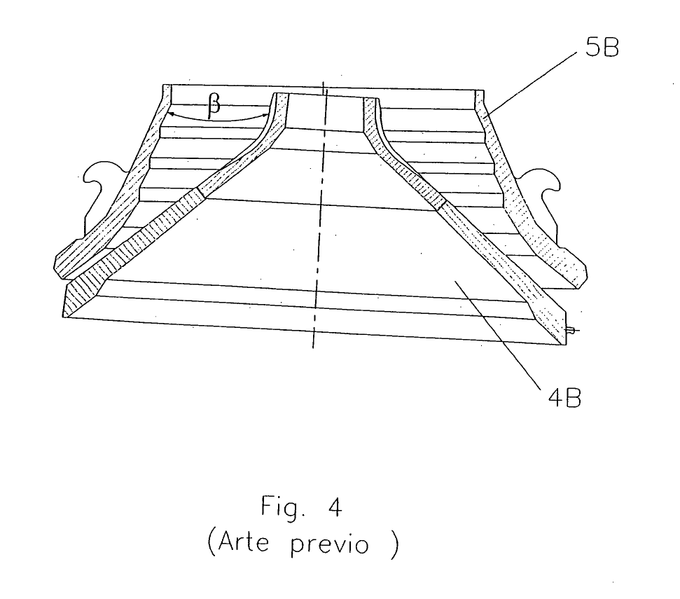

The above is explained by the fact, making reference to FIG. 3, that the clearance (α) between the groove (1) of the mantle (4) and the cup (5) will be smaller from the beginning in the upper part (2) shown in FIG. 1, in relation to the same clearance (β) between the mantle (4B) and the cup (5B) of FIG. 4 of the previous design, which clearly shows a cross section of a crusher where the mantle is typically a flat surface.

Therefore, the grinded material that enters comminuting into the crusher will achieve a second great objective, that is to have a longer and more homogenous residence time within said crusher and, hence, to render a more efficient operation, both in reducing the comminution energy and in increasing the volume of comminuted material per hour.

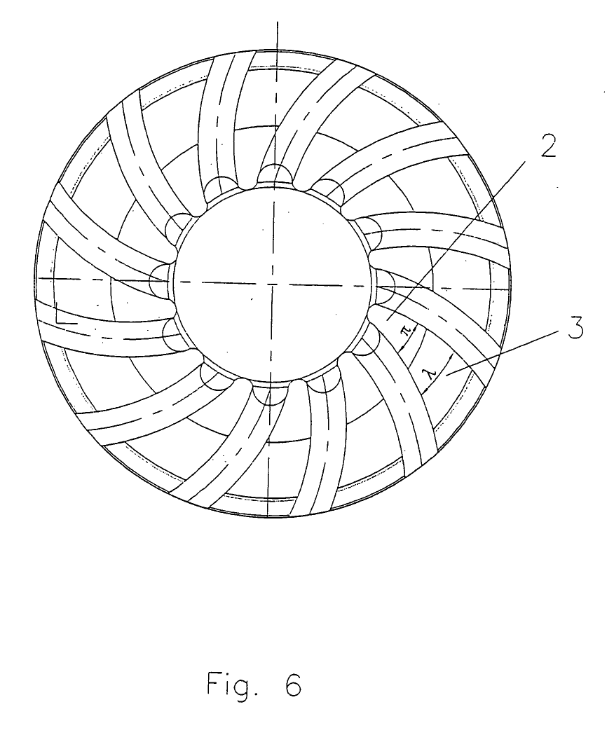

On the other hand, the spiral geometrical layout of the grooves (1) allows generating a curl effect of the grinded material, which makes it descend evenly from the upper part (2) to the lower part (3) of the armor. Also, as shown in FIG. 6, the clearance (π) in the upper part (2) is smaller than the clearance (k) of the lower part (3) of the armor, which is mainly due to the spiral geometrical layout of the grooves (1) mentioned above.

This clearance change between grooves (1) from the upper part (2) to the lower part (3) makes it possible that as the grinded material descends towards the setting area (6)—where the final desired size of the grinded material is defined—said material acquires an even particle size, since—as is to be expected—a large part of it was initially comminuted in the upper part (2) of the armor where the clearance (π) between grooves is especially tight. Thus, as the material continues descending towards the setting (6), said material is deposited in the space between grooves that increases towards the clearance (λ) and only a fraction that was not comminuted in the upper part (2) will then be comminuted by the grooves (1) themselves as it continues descending. So, the material will be mainly comminuted at the even size defined by the clearance established by the grooves (1) and the cup (5), thus preventing the material that was already grinded in the upper part (2) from being grinded in excess and generating undesired fine material that could cause a general jamming of the crusher.

Regarding the manufacture of the mantle armor of the present invention, we can state it has the great advantage that is built in a single casting where the grooves (1) are integral to the mantle (4), thus originating the mantle armor.

This mantle armor—designed to bear the high comminuting pressure—is steel casting as per ASTM A-128 Grade C standards, of high manganese with contents high in chrome.

Unlike the previous design, the mantle (4) has grooves (1) that belong to the same casting; therefore there is no presence of additional material. Also, the casting mold makes it possible that said grooves (1) adopt the shape of spires or helixes, which cling to the body of the mantle (4), where the cross section of the groove (1) has a half-round shape.

Finally, the embossing formed by the layout of grooves (1) over the mantle (4) may have various thicknesses (7), as shown in FIG. (5), mainly due to the type of material to be comminuted and to the desired particle size for the subsequent ore metallurgy processes.

1. A cone crusher mantle armor for ore comminution, comprising:
a. grooves laid out in the form of spires or helixes over the mantle, where such grooves are integral to said mantle thus forming the mantle armor, and
b. such grooves and said mantle are manufactured in a single casting.

2. The mantle armor of claim 1 wherein the clearance between grooves in the upper part of the mantle is smaller than the clearance between grooves in the lower part of the mantle.

3. The mantle armor of claim 1 wherein it is manufactured in high manganese steel with contents high in chrome.

4. The mantle armor of claim 1 wherein such grooves have a half-round cross section.
